(19) United States
(12) Patent Application Publication
(10) Pub. No.: US 2021/0040578 A1
(43) Pub. Date: Feb. 11, 2021

(54) HIGH DUCTILITY ZINC-COATED STEEL SHEET PRODUCTS

(71) Applicant: United States Steel Corporation, Pittsburgh, PA (US)

(72) Inventor: Larrin S. Thomas, Pittsburgh, PA (US)

(21) Appl. No.: 16/987,812

(22) Filed: Aug. 7, 2020

Related U.S. Application Data
(60) Provisional application No. 62/883,704, filed on Aug. 7, 2019.

(51) Int. Cl. C21D 9/46; C22C 38/02; C22C 38/04; C22C 38/06; C22C 38/22; C23C 2/06; C21D 1/18; C21D 8/02

(52) U.S. Cl. CPC C21D 9/46; C22C 38/02; C22C 38/04; C22C 38/06; C22C 38/22; C21D 2211/008; C21D 1/18; C21D 8/0273; C21D 2211/001; C21D 2211/005; C23C 2/06

(57) ABSTRACT

High ductility steel sheet products are disclosed that have controlled compositions that, in combination with controlled heating cycles, produce desirable microstructures and favorable mechanical properties including ultimate tensile strength of at least 1180 MPa, high ductility, hole expansion, bendability and formability. Steel compositions include controlled amounts of carbon, manganese, silicon, chromium, molybdenum and aluminum. Rolled sheets are subjected to a thermal cycle including a heating stage followed by quenching to below the martensite-start temperature and aging.

### CROSS-REFERENCE TO RELATED APPLICATION

This application claims the benefit of U.S. Provisional Patent Application No. 62/883,704 tiled Aug. 7, 2019, which is incorporated herein by reference.

### FIELD OF THE INVENTION

The present invention relates to high ductility zinc-coated steel sheet products, and more particularly relates to steel sheet products having controlled amounts of Si, Cr, Mo and Al alloying additions that are subjected to a quench and partition process to produce desirable mechanical properties including high ultimate tensile strength, high ductility and high hole expansion.

### BACKGROUND INFORMATION

Quench and partition steels typically have high silicon content so that carbide precipitation can be suppressed and austenite retained for a high combination of strength and ductility. Silicon additions of at least 1.5 weight percent are typical. However, such silicon additions lead to a grain boundary oxidation layer in hot-rolled steel which is difficult to remove during pickling. Silicon additions also have been linked to liquid metal embrittlement in welding of zinc-coated steels, leading to low-strength welds.

### SUMMARY OF THE INVENTION

The present invention provides high ductility steel sheet products having controlled compositions that, in combination with controlled heating cycles, produce desirable microstructures and favorable mechanical properties including ultimate tensile strength of at least 1180 MPa, high ductility, hole expansion, bendability and formability. The steel compositions include controlled amounts of carbon, manganese, silicon and chromium. Molybdenum and aluminum may be included in controlled amounts. Rolled sheets are subjected to a thermal cycle including a heating stage followed by quenching to below the martensite-start temperature and aging.

An aspect of the present invention is to provide a quench and partition steel sheet product comprising from 0.12 to 0.5 weight percent C, from 1 to 3 weight percent Mn, from 0.4 to 1.1 weight percent Si, from 0.2 to 0.9 weight percent Cr, up to 0.5 weight percent Mo, and up to 1 weight percent Al, wherein the steel sheet product comprises martensite, ferrite and retained austenite, and has an ultimate tensile strength of at least 1180 MPa, a total elongation of at least 13 percent, and a hole expansion of at least 25 percent.

Another aspect of the present invention is to provide a method of making the quench and partition steel sheet described above by heating the steel sheet product to a soaking temperature of at least 720° C., quenching the heated steel sheet product to a quench temperature below a martensite-start temperature, and aging the quenched steel sheet product at a temperature at or above the quench temperature to thereby produce the quench and partition steel sheet product.

A further aspect of the present invention is to provide a method of producing a quench and partition steel sheet product comprising from 0.12 to 0.5 weight percent C, from 1 to 3 weight percent Mn, from 0.4 to 1.1 weight percent Si, from 0.2 to 0.9 weight percent Cr, up to 0.5 weight percent Mo, and up to 1 weight percent Al. The method comprises subjecting the steel sheet product to a soaking temperature of at least 720° C., quenching the heated steel sheet product to a quench temperature below a martensite-start temperature, and aging the quenched steel sheet product at an aging temperature at or above the quench temperature to thereby produce the quench and partition steel sheet product. The steel sheet product comprises martensite, ferrite and retained austenite, and has an ultimate tensile strength of at least 1180 MPa, a total elongation of at least 13 percent, and a hole expansion of at least 25 percent.

These and other aspects of the present invention will be more apparent from the following description.

### BRIEF DESCRIPTION OF THE DRAWINGS

FIG. 1 is a plot of temperature versus time illustrating an optional first annealing process followed by a quench and partition thermal cycle including quenching and aging in accordance with an embodiment of the present invention.

FIG. 2 is a micrograph of a steel sheet product that was subjected to the quench and partition process of FIG. 1.

### DETAILED DESCRIPTION

High ductility steel sheet products of the present invention have controlled compositions that, in combination with a controlled heating cycle, produce desirable microstructures and favorable mechanical properties including ultimate tensile strength of at least 1180 MPa, high ductility, hole expansion, bendability and formability. The steel compositions include controlled amounts of carbon, manganese, silicon, chromium and molybdenum, and may also include aluminum, along with other suitable alloying additions known to those skilled in the art.

The present steel compositions may typically include from 0.12 to 0.5 weight percent C, from 1 to 3 weight percent Mn, from 0.4 to 1.1 weight percent Si, from 0.2 to 0.9 weight percent Cr, and up to 0.5 weight percent Mo. For example, the steel compositions may include from 0.15 to 0.4 weight percent. C, from 2 to 2.8 weight percent Mn, from 0.5 to 1.0 weight percent Si, from 0.15 to 0.8 weight percent Cr, and from 0.1 or 0.15 to 0.4 weight percent Mo. In certain embodiments, the steel composition may include from 0.2 to 0.25 weight percent C, from 2.1 to 2.5 weight percent Mn, from 0.6 to 0.9 weight percent Si, from 0.3 to 0.7 weight percent Cr, and from 0.2 to 0.3 weight percent Mo. Aluminum may be added to the steel composition in an amount up to 1 weight percent, for example, from 0.1 to 0.7 weight percent, or from 0.2 to 0.5 weight percent.

It has been discovered that controlled combinations of Mn, Si, Cr, Mo and Al result in superior properties in high ductility 1180 sheet steel products with relatively low Si content of less than 1.1 weight percent, or less than 1.0 weight percent, or less than 0.95 weight percent, or less than 0.90 weight percent, or less than 0.85 weight percent, or less than 0.80 weight percent. Low Si provides ease in processing and good resistance to liquid metal embrittlement during welding of zinc coated sheets.

In the steel sheet products of the present invention, C provides increased strength and promotes the formation of retained austenite. Mn provides hardening and acts as a solid solution strengthener. Si inhibits iron carbide precipitation during heat treatment, and increases austenite retention. Cr in combination with Mo provides tempering resistance and can inhibit carbide precipitation, particularly when used in combination with Si or Si and Al. Al inhibits iron carbide precipitation during heat treatment, and increases austenite retention. Ti and Nb may optionally be added as a strength-enhancing grain refiners.

In addition to the amounts of C, Mn, Si, Cr, Mo and Al listed above, the steel compositions may include minor or impurity amounts of other elements, such as up to 0.05 Ti, up to 0.05 Nb, 0.015 max S, 0.03 max P, 0.2 max Cu, 0.2 max Ni, 0.1 max Sn, 0.015 max N, 0.1 max V, and 0.004 max B. As used herein the term “substantially free”, when referring to the composition of the steel sheet product, means that a particular element or material is not purposefully added to the composition, and is only present as an impurity or in trace amounts.

Steel sheet products having compositions as described above are subjected to a quench and partition heating process, as more fully described below. The resultant sheet products have been found to possess favorable mechanical properties including high elongation, desirable ultimate tensile and yield strength, high bendability and high hole expansion.

The steel sheet products may have high ductility, as measured by total elongation (TE) using the standard ASTM-L test, typically of at least 12 percent, for example, at least 13 percent, or at least 14 percent, or at least 15 percent. For example, the steel sheet product may have a total elongation of from 13 or 14 percent to 19 percent or higher.

The ultimate tensile strength (UTS) of the steel sheet products is typically at least 1180 MPa, for example, from 1180 to 1370 MPa. In certain embodiments, the UTS may be less than 1370 MPa, or less than 1350 MPa, or less than 1320 MPa. The yield strength (YS) of the steel sheet products is typically at least 700 MPa, for example, from 700 to 1,100 MPa,

Strength elongation balance (UTS·TE) of greater than 15,000 MPa % may be achieved by the steel sheet products, for example, greater than 17,000 MPa %, or greater than 18,000 MPa %, or greater than 20,000 MPa %.

The steel sheet products have high hole expansion (HE), for example, at least 25 percent, or at least 30 percent, or at least 32 percent, or at least 34 percent.

The combination of UTS·TE·HE (MPa %²) may be greater than 37.5×10⁴ for the steel sheet products, for example, greater than 42.5×10⁴, or greater than 50×10⁴, or greater than 54×10⁴, or greater than 64×10⁴, or greater than 68×10⁴.

The steel sheet products have high bendability R/T for example, at least 2 R/T, or at least 2.5 R/T.

In accordance with certain embodiments of the invention, the final microstructure of the steel sheet products may primarily comprise martensite, e.g., from 50 to 80 volume percent, with lesser amounts of ferrite, e.g., from 5 to 35 volume percent, and lesser amounts of retained austenite, e.g., from 1 to 20 volume percent. The retained austenite may typically comprise greater than 5 volume percent, or greater than 8 volume percent. In certain embodiments, the retained austenite may comprise from 5 to 16 volume percent, or from 8 to 15 volume percent, or from 10 to 14 volume percent, or from 11 to 12 volume present. Bainite may also be present in minor amounts, e.g., from zero to 5 volume percent or 10 volume percent or 15 volume percent. The amounts of such phases may be determined by standard EBSD techniques.

The prior austenite may have an average grain size of from 1 to 20 microns, for example, from 5 to 10 microns. The ferrite may have an average grain size of from 1 to 20 microns, for example, from 3 to 5 microns. The retained austenite may have an average grain size of less than 2 microns, or less than 1 micron, or less than 0.5 micron. The retained austenite grains may be substantially equiaxed and may have an average aspect ratio of less than 3:1, or less than 2:1, or less than 1.9:1.

### Quench and Partition Thermal Cycle

The quench and partition thermal cycle involves heating followed by quenching to below the martensite-start temperature and directly aging, either at, or above, the initial quench temperature. Carbide precipitation is suppressed by appropriate alloying, and the carbon partitions from the supersaturated martensite phase to the untransformed austenite phase, thereby increasing the stability of the residual austenite upon subsequent cooling to room temperature. This treatment may be referred to as quenching and partitioning (Q&P).

A first annealing or soaking stage may be conducted at relatively high annealing temperatures, a second quenching or cooling stage where the temperature is reduced below martensite start, and a third aging or holding stage in which the sheet product is reheated to a relatively low hold temperature and held for a desired period of time. The temperatures are controlled in order to promote the formation of the desired microstructure and mechanical properties in the final product.

After partial or full austenitization in the soaking stage, the steel is quenched to a temperature (QT) calculated to produce a pre-determined fraction of martensite and balancing fraction of untransformed austenite. The steel is then raised to the partitioning temperature (PT), when carbon escapes into the untransformed austenite, raising its chemical stability so that after subsequent cooling to ambient after partitioning, austenite is retained. As the untransformed austenite is enriched with carbon during partitioning, its effective Mₛ−M_{f} temperature range is suppressed. For chemical stabilization the Mₛ should be depressed to room temperature or below.

In the first annealing stage, a soaking zone temperature between A₁ and A₃ may be used, for example, an annealing temperature of at least 720° C. may be used. In certain embodiments, the soaking zone temperature may typically range from 720 to 890° C., for example, from 760 to 825° C. In certain embodiments, the peak annealing temperature may be typically held for at least 15 seconds, for example, from 20 to 300 seconds, or from 30 to 150 seconds.

The soaking zone temperature may be achieved by heating the steel from a relatively low temperature below Mₛ, e.g., room temperature, at an average rate of from 0.5 to 50° C./sec, for example, from about 2 to 20° C./sec. In certain embodiments, the ramp-up may take from 25 to 800 seconds, for example, from 100 to 500 seconds. The first stage heating of the second cycle may be accomplished by any suitable heating system or process, such as using radiant heating, induction heating, direct fired furnace heating and the like.

After the soaking zone temperature is reached and held for the desired period of time, the steel may be cooled to a controlled temperature above room temperature to the holding zone. The steel may be cooled to below martensite start through water cooling, gas cooling, and the like to form martensite. A typical overall quench rate of from 5 to 200° C./sec, for example, from 20 to 100° C./sec, or from 30 to 80° C./sec may be used. Quenching may reduce the temperature of the steel sheet product to a typical quench temperature of from 150 to 0° C., for example, from 220 to 300° C., or from 250 to 280° C. Any suitable types of cooling and quenching systems may be adapted for use in cooling from the soaking temperature to the holding temperature, including those described above.

In certain embodiments, multiple quench rates may be used, such as a first relatively slow quench rate followed by a second relatively fast quench rate. For example, the first quench rate may be from 1 to 30° C. per second to reach a first quench temperature of from 500 to 800° C., then a second quench rate of from 5 to 200° C. per second to reach the final quench temperature described above. In certain embodiments, the first quench rate may be from 5 to 20° C. per second to reach a first quench temperature of from 630 to 700° C., then a second quench rate of from 20 to 200° C. per second to reach the final quench temperature.

After quenching, the steel is then heated to a higher hold temperature for tempering and the partitioning process described above. In certain embodiments, the steel sheet product is maintained at a temperature above 300° C. between the soaking and holding stages.

In accordance with embodiments of the invention, the aging or holding zone step is carried out at a typical temperature of from 300 to 440° C., for example, from 370 to 430° C. The holding zone may be held for up to 800 seconds, for example, from 30 to 600 seconds. For example, aging may be performed at a PT of from 350 to 450° C. for from 30 to 300 seconds, or from 370 to 430° C. for from 60 to 180 seconds.

The holding zone temperature may be held constant, or may be varied somewhat within a selected temperature range. After holding, the steel may be reheated, such as by induction or other heating method, e.g., to a temperature of about 470° C. to enter a hot-dip coating pot at the proper temperature for good coating results, if the steel is to be hot-dip coated.

In certain embodiments, after the aging or holding zone temperature has been maintained for a desired period of time, the temperature may be ramped down to room temperature. Such a ramp-down may typically take from 10 to 1,000 seconds, for example, from about 20 to 500 seconds. The rate of such ramp-down may typically range from 1 to 1,000° C./sec, for example, from 2 to 20° C./sec.

In certain embodiments, the quench and partition steel sheet is hot-dip galvanized at the end of the holding zone. Galvanizing temperatures may typically range from 440 to 480° C., for example, from 450 to 470° C. Alternatively, or in addition, galvannealing may be performed at a typical temperature of from 480° C. to 530° C.

In certain embodiments, the galvanizing step may be performed as part of the second-step annealing process on a continuous galvanizing line (CGL). This CAL+CGL process can be used to produce both a zinc-based or zinc alloy-based hot-dip galvanized product or reheated after coating to produce an iron-zinc galvanneal type coated product. An optional nickel-based coating step can take place between the CAL and CGL steps in the process to improve zinc coating properties. The use of a continuous galvanizing line in the second step may increase the production efficiency of producing a coated product versus using a CAL+CAL+EG route. A galvanized product or zinc-based alloy hot-dip coated product can also be made on a specially designed CGL in which the two-step annealing can take place in a single line. Galvannealing can also be an option in this case. Furthermore, a single production facility can also be specially designed and built to combine the two cycle thermal process to produce steel sheet products.

### Initial Thermal Cycle

In certain embodiments of the invention, a two thermal cycle process is used to produce high ductility and strength steel products with favorable mechanical properties, such as those described above. Within each of the first and second thermal cycles, multiple methodologies for undertaking the heat treatment may be used. Examples of a first thermal cycle annealing process are described in U.S. Pat. No. 10,385,419, which is incorporated herein by reference. A continuous annealing line (CAL) may be used for the first cycle, followed by a continuous galvanizing line (CGL) for the second cycle.

An initial annealing process may be used, e.g., to achieve a martensitic microstructure. In accordance with an embodiment of the invention, in a first annealing stage of the first thermal cycle, an annealing temperature above the A₃ temperature may be used, for example, an annealing temperature of at least 820° C. may be used. In certain embodiments, the first stage annealing temperature may typically range from 830 to 980° C., for example, from 830 to 940° C., or from 840 to 930° C., or from 860 to 925° C. In certain embodiments, the peak annealing temperature may be typically held for at least 20 seconds, for example, from 20 to 500 seconds, or from 30 to 200 seconds. Heating may be accomplished by conventional techniques such as a non-oxidizing or oxidizing direct-fired furnace (DFF), oxygen-enriched DFI, induction, gas radiant tube heating, electric radiant heating, and the like. Examples of heating systems that may be adapted for use in the processes of the present invention are disclosed in U.S. Pat. Nos. 5,798,007; 7,368,689; 8,425,225; and 8,845,324, U.S. Patent Application No. 2009/0158975, and Published PCT Application No. WO/2015083047, assigned to Fives Stein. Additional examples of heating systems that may be adapted for use in the processes of the present invention include U.S. Pat. No. 7,384,489 assigned to Dreyer International, and U.S. Pat. No. 9,096,918 assigned to Nippon Steel and Sumitomo Metal Corporation. Any other suitable known types of heating systems and processes may be adapted for use in the first and second cycles.

In the first stage, after the peak annealing temperature is reached and held for the desired period of time, the steel is quenched to room temperature, or to a controlled temperature above room temperature, as more fully described below. The quench temperature may not necessarily be room temperature but should be below the martensite start temperature (Mₛ), and preferably below the martensite finish temperature (M_{F}), to form a microstructure of predominantly martensite. In certain embodiments, between the first step process and the second step process, the steel sheet product may be cooled to a temperature below 300° C., for example, below 200° C.

Quenching may be accomplished by conventional techniques such as water quenching, submerged knife/nozzle water quenching, gas cooling, rapid cooling using a combination of cold, warm or hot water and gas, water solution cooling, other liquid or gas fluid cooling, chilled roll quench, water mist spray, wet flash cooling, non-oxidizing wet flash cooling, and the like. A quench rate of from 30 to 2,000° C./sec may typically be used.

Various types of cooling and quenching systems and processes known to those skilled in the art may be adapted for use in the processes of the present invention. Suitable cooling/quenching systems and processes conventionally used on a commercial basis may include water quench, water mist cooling, dry flash and wet flash, oxidizing and non-oxidizing cooling, alkane fluid to gas phase change cooling, hot water quenching, including two-step water quenching, roll quenching, high percentage hydrogen or helium gas jet cooling, and the like. For example, dry flash and/or wet flash oxidizing and non-oxidizing cooling/quenching such as disclosed in published PCT Application No. WO2015/083047 to Fives Stein may be used. Other Fives Stein patent documents describing cooling/quenching systems and processes that may be adapted for use in the processes of the present invention include U.S. Pat. Nos. 6,464,808B2; 6,547,898B2, and 8,918,199B2, and U.S. Patent Application Publication Nos. US2009/0158975A1; US2009/0315228A1; and US2011/0266725A1. Other examples of cooling/quenching systems and processes that may be adapted for use in the processes of the present invention include those disclosed in U.S. Pat. Nos. 8,359,894B2; 8,844,462B2; and 7,384,489B2, and U.S. Patent Application Publication Nos. 2002/0017747A1 and 2014/0083572A1.

In certain embodiments, after the first-stage peak annealing temperature is reached and the steel is quenched to form martensite, the martensite can be optionally tempered to soften the steel somewhat to make further processing more feasible. Tempering takes place by raising the temperature of the steel in the range of room temperature to about 500° C. and holding for up to 600 seconds. If tempering is utilized, the tempering temperature may be held constant, or may be varied within this preferred range.

After tempering, the temperature may be ramped down to room temperature. The rate of such ramp-down may typically range from 1 to 40° C./sec, for example, from 2 to 20° C./sec. In the case of a single pass facility furnace, tempering may not be necessary.

In accordance with certain embodiments, one or both of the initial thermal cycle and quench and partition thermal cycle processes may be performed on a continuous annealing line (CAL). After going through a CAL+CAL process, the steel may be electrogalvanized to produce a zinc based coated product, and may also be galvannealed if desired.

The following examples are intended to illustrate various aspects of the present invention, and are not intended to limit the scope of the invention.

### EXAMPLE 1

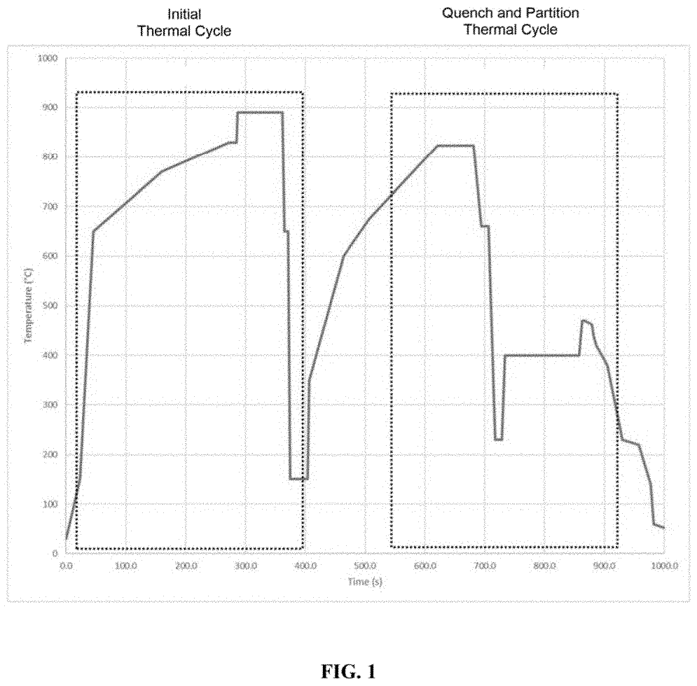

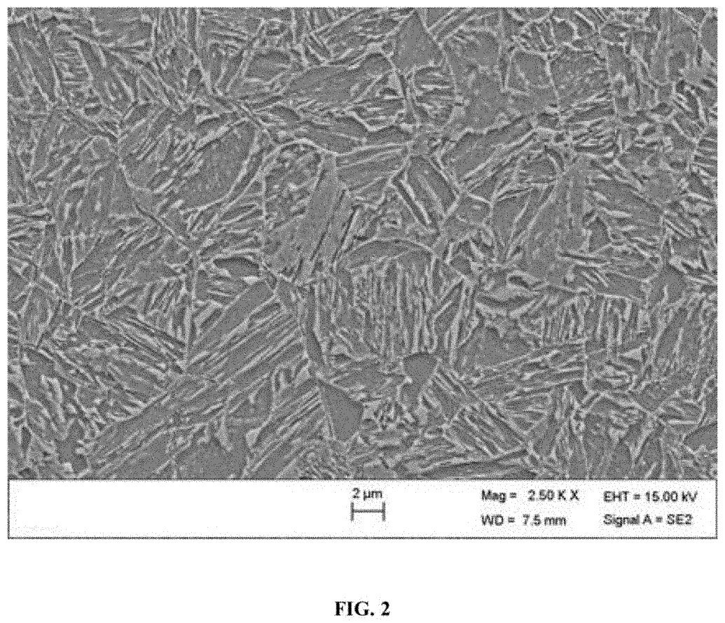

A cold rolled steel sheet having a composition of 0.22 weight percent C, 2.3 weight percent Mn, 1.0 weight percent Si, 0.5 weight percent Cr, 0.25 weight percent Mo and 0.4 weight percent Al was subjected to a two-cycle heating process as illustrated in FIG. 1. As shown in FIG. 1, in the first cycle, the steel sheet is heated to 90° C. to austenitize the steel, and rapidly cooled. In the second quench and partition cycle, a peak temperature of 823° C. is reached, then the sheet is slow jet cooled to 660° C. rapidly quenched to 230° C., overaged at 400° C. and coated with zinc from about 470° C. The following processing parameters were used (° C.): 930 RTS1; 660 SJC1, 30 RJC1, 800 RTS2, 660 SJC2, 231 RJC2, 400 OA1, 400 OA2 and 470 GI. The resultant steel product included 12.7 percent retained austenite (RA), and exhibited the following mechanical properties: 41% HE, 1016 MPa YS, 1222 MPa UTS, 12.3% UE, 16.6% TE, and 20285 MPa. % UTS·TE. The microstructure of the resultant product is shown in FIG. 2. The microstructure is primarily made up of tempered martensite with a combination of elongated interlath and small equiaxed grains of retained austenite in an amount of 12.7 percent. A small amount of equiaxed ferrite may also be present. There may also be a small amount of carbide-free bainite.

Cold rolled steel sheets having compositions as listed in Table 1 were subjected to quench and partition heating processes as listed in Table 2. The resultant steel sheet products exhibited mechanical properties as listed in Table 3.

TABLE 1
Compositions (weight percent)

| Sample | | | | | | | |
|---|---|---|---|---|---|---|---|
| No. | C | Mn | Si | Cr | Mo | Al | Nb |
| 1 | 0.22 | 2.32 | 1.02 | 0.40 | | | |
| 2 | 0.72 | 2.32 | 1.02 | 0.40 | | | |
| 3 | 0.22 | 2.32 | 1.02 | 0.40 | | | |
| 4 | 0.22 | 2.33 | 1.02 | 0.40 | | 0.201 | |
| 5 | 0.21 | 2.33 | 1.02 | 0.40 | | 0.201 | |
| 6 | 0.22 | 2.32 | 1.02 | 0.39 | | 0.385 | |
| 7 | 0.21 | 2.15 | 1.02 | 0.79 | | | |
| 8 | 0.21 | 2.15 | 1.02 | 0.79 | | | |
| 9 | 0.21 | 2.15 | 1.02 | 0.79 | | | |
| 10 | 0.22 | 2.15 | 1.03 | 0.79 | | 0.202 | |
| 11 | 0.21 | 2.14 | 1.02 | 0.79 | | 0.391 | |
| 12 | 0.21 | 2.14 | 1.02 | 0.79 | | 0.391 | |
| 13 | 0.21 | 2.14 | 1.02 | 0.79 | | 0.391 | |
| 14 | 0.21 | 2.51 | 1.00 | 0.51 | | | |
| 15 | 0.22 | 2.75 | 1.01 | 0.51 | | | |
| 16 | 0.21 | 2.75 | 1.02 | 0.50 | | 0.47 | |
| 17 | 0.21 | 2.75 | 1.02 | 0.50 | | 0.47 | |
| 18 | 0.21 | 2.75 | 1.02 | 0.50 | | 0.47 | |
| 19 | 0.21 | 2.75 | 1.02 | 0.50 | | 0.47 | |
| 20 | 0.22 | 2.24 | 1.01 | 0.50 | 0.25 | | |
| 21 | 0.22 | 2.24 | 1.01 | 0.50 | 0.25 | | |
| 22 | 0.22 | 2.24 | 1.01 | 0.50 | 0.25 | | |
| 23 | 0.22 | 2.24 | 1.01 | 0.50 | 0.25 | | |
| 24 | 0.23 | 2.23 | 1.01 | 0.50 | 0.25 | 0.21 | |
| 25 | 0.23 | 2.48 | 1.01 | 0.50 | 0.25 | 0.41 | |
| 26 | 0.21 | 2.28 | 1.01 | 0.50 | | | |
| 27 | 0.21 | 2.28 | 1.01 | 0.50 | | | |
| 28 | 0.21 | 2.28 | 1.01 | 0.50 | | | |
| 29 | 0.21 | 2.28 | 1.01 | 0.50 | | | |
| 30 | 0.71 | 2.28 | 1.01 | 0.50 | | | |
| 31 | 0.23 | 2.28 | 1.01 | 0.50 | | | |
| 32 | 0.23 | 2.28 | 1.01 | 0.50 | | | |
| 33 | 0.23 | 2.28 | 1.01 | 0.50 | | | |
| 34 | 0.23 | 2.28 | 1.01 | 0.50 | | | |
| 35 | 0.23 | 2.28 | 1.01 | 0.50 | | | |
| 36 | 0.23 | 2.26 | 0.99 | 0.50 | 0.24 | | |
| 37 | 0.23 | 2.26 | 0.99 | 0.50 | 0.24 | | |
| 38 | 0.21 | 2.27 | 1.00 | 0.50 | | 0.2 | |
| 39 | 0.21 | 2.28 | 1.01 | 0.50 | | 0.4 | |
| 40 | 0.21 | 2.27 | 0.99 | 0.50 | 0.25 | 0.4 | |
| 41 | 0.21 | 2.27 | 0.99 | 0.50 | 0.25 | 0.4 | |
| 42 | 0.21 | 2.27 | 0.99 | 0.50 | 0.25 | 0.4 | |
| 43 | 0.21 | 2.27 | 0.99 | 0.50 | 0.25 | 0.4 | |
| 44 | 0.22 | 2.27 | 0.63 | 0.50 | 0.25 | 0.43 | |
| 45 | 0.22 | 2.27 | 0.63 | 0.50 | 0.25 | 0.43 | |
| 46 | 0.22 | 2.27 | 0.63 | 0.50 | 0.25 | 0.43 | |
| 47 | 0.22 | 2.26 | 0.70 | 0.50 | 0.25 | 0.43 | |
| 48 | 0.22 | 2.26 | 0.70 | 0.50 | 0.25 | 0.43 | |
| 49 | 0.22 | 2.26 | 0.70 | 0.50 | 0.25 | 0.43 | |
| 50 | 0.22 | 2.26 | 0.70 | 0.50 | 0.25 | 0.43 | |
| 51 | 0.21 | 2.29 | 0.79 | 0.50 | 0.25 | 0.41 | 0.028 |

TABLE 2
Themal Cycles (° C.)

| Sample | | | | | | | | | | |
|---|---|---|---|---|---|---|---|---|---|---|
| No. | RTS1 | SJC1 | RJC1 | RTS2 | SJC2 | RJC2 | OA1 | OA2 | GI | GA |
| 1 | 930 | 660 | 30 | 800 | 660 | 280 | 400 | 400 | 470 | |
| 2 | 890 | 660 | 30 | 790 | 660 | 250 | 300 | 350 | 470 | |
| 3 | 890 | 660 | 30 | 790 | 660 | 250 | 300 | 350 | 470 | 510 |
| 4 | 930 | 650 | 30 | 840 | 660 | 280 | 300 | 350 | 470 | |
| 5 | 930 | 660 | 30 | 820 | 660 | 260 | 300 | 350 | 470 | |
| 6 | 930 | 650 | 30 | 880 | 730 | 300 | 400 | 400 | 470 | |
| 7 | 930 | 660 | 30 | 800 | 660 | 210 | 300 | 350 | 470 | |
| 8 | 930 | 660 | 30 | 790 | 660 | 230 | 300 | 350 | 470 | |
| 9 | 890 | 660 | 30 | 790 | 660 | 230 | 300 | 350 | 470 | 510 |
| 10 | 890 | 660 | 30 | 832 | 660 | 280 | 300 | 320 | 470 | 510 |
| 11 | 930 | 650 | 30 | 870 | 660 | 280 | 300 | 350 | 470 | |
| 12 | 890 | 660 | 30 | 865 | 660 | 260 | 300 | 320 | 470 | 510 |
| 13 | 890 | 660 | 30 | 865 | 660 | 280 | 300 | 350 | 470 | 510 |
| 14 | 890 | 800 | 30 | 750 | 660 | 195 | 400 | 400 | 470 | 480 |
| 15 | 890 | 800 | 30 | 778 | 660 | 223 | 400 | 400 | 470 | 480 |
| 16 | 890 | 800 | 30 | 799 | 660 | 205 | 400 | 400 | 470 | |
| 17 | 890 | 800 | 30 | 799 | 660 | 205 | 400 | 400 | 470 | 480 |
| 18 | 890 | 800 | 30 | 799 | 660 | 205 | 400 | 400 | 470 | 500 |
| 19 | 890 | 800 | 30 | 799 | 660 | 205 | 400 | 400 | 470 | 520 |
| 20 | 890 | 800 | 30 | 780 | 660 | 240 | 400 | 400 | 470 | |
| 21 | 890 | 800 | 30 | 780 | 660 | 240 | 400 | 400 | 470 | 480 |
| 22 | 890 | 800 | 30 | 780 | 660 | 240 | 400 | 400 | 470 | 500 |
| 23 | 890 | 800 | 30 | 780 | 660 | 240 | 400 | 400 | 470 | 520 |
| 24 | 890 | 800 | 30 | 798 | 660 | 246 | 400 | 400 | 470 | 480 |
| 25 | 890 | 800 | 30 | 790 | 660 | 219 | 400 | 400 | 470 | 480 |
| 26 | 890 | 800 | 30 | 788 | 660 | 216 | 400 | 400 | 470 | |
| 27 | 890 | 800 | 30 | 788 | 660 | 216 | 400 | 400 | 470 | 480 |
| 28 | 890 | 800 | 30 | 788 | 660 | 216 | 400 | 400 | 470 | 500 |
| 29 | 890 | 800 | 30 | 788 | 660 | 216 | 400 | 400 | 470 | 480 |
| 30 | 890 | 800 | 30 | 788 | 660 | 216 | 400 | 400 | 470 | 520 |
| 31 | 890 | 800 | 30 | 772 | 660 | 197 | 400 | 400 | 470 | |
| 32 | 890 | 800 | 30 | 772 | 660 | 197 | 400 | 400 | 470 | 480 |
| 33 | 890 | 800 | 30 | 772 | 660 | 197 | 400 | 400 | 470 | 480 |
| 34 | 890 | 800 | 30 | 772 | 660 | 197 | 400 | 400 | 470 | 500 |
| 35 | 890 | 800 | 30 | 772 | 660 | 197 | 400 | 400 | 470 | 520 |
| 36 | 890 | 800 | 30 | 880 | 660 | 280 | 400 | 400 | 470 | 480 |
| 37 | 890 | 800 | 30 | 880 | 660 | 260 | 400 | 400 | 470 | 480 |
| 38 | 890 | 800 | 30 | 800 | 660 | 216 | 400 | 400 | 470 | 480 |
| 39 | 890 | 800 | 30 | 841 | 660 | 288 | 400 | 400 | 470 | 480 |
| 40 | 890 | 800 | 30 | 823 | 660 | 231 | 400 | 400 | 470 | |
| 41 | 890 | 800 | 30 | 823 | 660 | 231 | 400 | 400 | 470 | 480 |
| 42 | 890 | 800 | 30 | 823 | 660 | 231 | 400 | 400 | 470 | 500 |
| 43 | 890 | 800 | 30 | 823 | 660 | 231 | 400 | 400 | 470 | 520 |
| 44 | 890 | 800 | 30 | 811 | 660 | 270 | 400 | 400 | 470 | |
| 45 | 890 | 800 | 30 | 811 | 660 | 270 | 400 | 400 | 470 | 500 |
| 46 | 890 | 800 | 30 | 811 | 660 | 270 | 400 | 400 | 470 | 520 |
| 47 | 890 | 800 | 30 | 814 | 660 | 270 | 400 | 400 | 470 | |
| 48 | 890 | 800 | 30 | 814 | 660 | 270 | 400 | 400 | 470 | 500 |
| 49 | 890 | 800 | 30 | 814 | 660 | 270 | 400 | 400 | 470 | 520 |
| 50 | 890 | 800 | 30 | 814 | 660 | 250 | 400 | 400 | 470 | 520 |
| 51 | 890 | 800 | 30 | 817 | 660 | 230 | 400 | 400 | 470 | 480 |

TABLE 3
Mechanical Properties

| Sample | | | | | | | UTS-TE |
|---|---|---|---|---|---|---|---|
| No. | RA (%) | HE (%) | YS (MPa) | UTS (MPa) | UE (%) | TE (%) | (MPa%) |
| 1 | 15.1 | 22 | 903 | 1223 | 10.7 | 15.3 | 18712 |
| 2 | 11.9 | 38 | 931 | 1230 | 11.1 | 15.7 | 19311 |
| 3 | 10.3 | 31 | 808 | 1196 | 8.4 | 12.6 | 15070 |
| 4 | 16.1 | 33 | 1077 | 1228 | 8.7 | 13.6 | 16701 |
| 5 | 12.9 | 33 | 1037 | 1221 | 9.9 | 15.1 | 18437 |
| 6 | 15.5 | | 1067 | 1194 | 9.3 | 14.9 | 17791 |
| 7 | 9.9 | 44 | 1020 | 1232 | 9.5 | 14.2 | 17494 |
| 8 | 11.4 | 34 | 927 | 1225 | 11.6 | 16.7 | 20458 |
| 9 | 10 | 19 | 809 | 1200 | 7.6 | 11.3 | 13560 |
| 10 | 12.8 | 23 | 879 | 1232 | 8.0 | 12.4 | 15277 |
| 11 | 16 | 32 | 1044 | 1209 | 8.6 | 14.1 | 17047 |
| 12 | 11.2 | 39 | 968 | 1199 | 9.7 | 14.1 | 16906 |
| 13 | 12.9 | 31 | 955 | 1196 | 9.7 | 13.7 | 16385 |
| 14 | 14.2 | 28 | 670 | 1231 | 10.6 | 14.7 | 18096 |
| 15 | 11.7 | 27 | 945 | 1298 | 9.6 | 13.9 | 18042 |
| 16 | 16.1 | 28 | 992 | 1242 | 13.7 | 18.5 | 22977 |
| 17 | 14.6 | 24 | 971 | 1252 | 13.9 | 18.7 | 23412 |
| 18 | 16 | 28 | 902 | 1238 | 12.4 | 16.9 | 20922 |
| 19 | 11.3 | 27 | 891 | 1207 | 9.6 | 17.3 | 20881 |
| 20 | 14 | 24 | 894 | 1280 | 11.8 | 16.1 | 20608 |
| 21 | 14.4 | 18 | 968 | 1304 | 10.8 | 15.4 | 20082 |
| 22 | 12.2 | 22 | 987 | 1302 | 8.5 | 11.5 | 14973 |
| 23 | 10.3 | 21 | 816 | 1268 | 7.3 | 9.8 | 12426 |
| 24 | 15 | 25 | 1026 | 1278 | 11.7 | 16.6 | 21215 |
| 25 | 19 | 24 | 879 | 1305 | 15.8 | 20.2 | 26361 |
| 26 | 12.3 | 39 | 992 | 1213 | 9.1 | 10.9 | 13222 |
| 27 | 9.2 | 40 | 907 | 1212 | 8.4 | 12.7 | 15392 |
| 28 | 9.9 | 37 | 877 | 1199 | 7.1 | 9.8 | 11750 |
| 29 | 10.2 | 33 | 920 | 1203 | 9.8 | 14.7 | 17684 |
| 30 | 8.1 | 35 | 888 | 1166 | 7.3 | 11.3 | 13176 |
| 31 | 11.4 | 29 | 947 | 1266 | 8.8 | 12.3 | 15572 |
| 32 | 10.1 | 33 | 930 | 1245 | 10.6 | 15.3 | 19049 |
| 33 | 11.5 | 36 | 918 | 1267 | 9.6 | 14.7 | 18625 |
| 34 | 8.8 | 37 | 864 | 1223 | 8.4 | 12.5 | 15288 |
| 35 | 8.2 | 15 | 874 | 1180 | 6.7 | 11.1 | 13098 |
| 36 | 14.2 | 19 | 973 | 1286 | 10.6 | 15.2 | 19547 |
| 37 | 14.9 | 38 | 1005 | 1296 | 10.1 | 14.4 | 18662 |
| 38 | 10.2 | 43 | 877 | 1179 | 10.8 | 15.3 | 18039 |
| 39 | 15.9 | 28 | 896 | 1163 | 12.5 | 15.8 | 18375 |
| 40 | 12.7 | 41 | 1016 | 1222 | 12.0 | 16.6 | 20285 |
| 41 | 11.7 | 34 | 989 | 1245 | 12.3 | 16.6 | 20667 |
| 42 | 11.5 | 36 | 1022 | 1222 | 11.7 | 16.4 | 20041 |
| 43 | 11.1 | 34 | 928 | 1212 | 8.5 | 12.6 | 15271 |
| 44 | 14 | 27 | 1056 | 1225 | 9.9 | 14.8 | 18130 |
| 45 | 13.7 | 34 | 979 | 1199 | 10.2 | 14.8 | 17745 |
| 46 | 13.2 | 27 | 919 | 1197 | 9.5 | 14.5 | 17357 |
| 47 | 17 | 38 | 1020 | 1200 | 10.5 | 15.6 | 18720 |
| 48 | 15 | 33 | 988 | 1199 | 10.8 | 15.4 | 18465 |
| 49 | 14.7 | 39 | 929 | 1188 | 11.0 | 16.2 | 19246 |
| 50 | 12.2 | 32 | 918 | 1222 | 10.8 | 15.3 | 18697 |
| 51 | 16.5 | 18 | 875 | 1248 | 12.9 | 17.3 | 21590 |

In accordance with embodiments of the invention, the amount of Si is reduced white adding relatively low amounts of Al. In contrast, partial replacements of silicon with significant amounts of aluminum leads to lower strength and a reduction in the strength-ductility balance. A comparative steel with 0.24 weight percent carbon, 2.4 weight percent manganese, 0.6 weight percent Si and 0.8 weight percent Al resulted in properties of 1018 Mpa YS, 1100 MPa UTS, 8.6% UE and 14.2% TE. In this sample, the following processing parameters were used (C°): 930 RTS1, 800 SJC1, 30 RC1, 900 RTS2, 730 SJC2, 270 RJC2, 360 OA1, 360 OA2, 470 GI AND 510 GA. It was found that such annealing parameters did not result in reaching the desired ultimate tensile strength of 1180 MPa.

With 1 weight percent Si and relatively low amounts of Al, and with a 0.4-0.8 weight percent Cr addition, the strength minimum can be achieved (see Sample Nos. 4-6, 10-13 and 38-39), although with total elongation of 12-14 percent. An aluminum addition somewhat increased total elongation, although in some cases also led to a reduction in strength. Table 4 compares Al-containing Sample Nos. 12 and 13 with Al-free Sample Nos. 3 and 9.

TABLE 4
Compositions (weight percent)

| Sample | | | | | | | | | | | |
|---|---|---|---|---|---|---|---|---|---|---|---|
| No. | C | Mn | Si | Cr | Mo | Al | HE | YS | UTS | UE | TE |
| 3 | 0.22 | 2.32 | 1.02 | 0.40 | 0 | 0 | 31 | 808 | 1196 | 8.4 | 12.6 |
| 9 | 0.21 | 2.15 | 1.02 | 0.79 | 0 | 0 | 19 | 809 | 1200 | 7.6 | 11.3 |
| 12 | 0.21 | 2.14 | 1.02 | 0.79 | 0 | 0.391 | 39 | 968 | 1199 | 9.7 | 14.1 |
| 13 | 0.21 | 2.14 | 1.02 | 0.79 | 0 | 0.391 | 31 | 955 | 1196 | 9.7 | 13.7 |

With an increase in Mn (see Sample Nos. 14-19), the strength and elongation was increased, but strength was relatively high at approximately 1300 MPa and hole expansion was reduced. An aluminum addition reduced strength and increased elongation, but hole expansion remained low, as shown in Table 5.

TABLE 5
Compositions (weight percent)

| Sample | | | | | | | | | | | |
|---|---|---|---|---|---|---|---|---|---|---|---|
| No. | C | Mn | Si | Cr | Mo | Al | HE | YS | UTS | UE | TE |
| 15 | 0.22 | 2 75 | 1.01 | 0.51 | 0 | 0.00 | 27 | 945 | 1298 | 9.6 | 13.9 |
| 17 | 0.21 | 2.75 | 1.02 | 0.50 | 0 | 0.47 | 24 | 971 | 1252 | 13.9 | 18.7 |

With a 0.25 weight percent Mo addition (see Sample Nos. 20-25 and 40-50), the strength was increased with similar elongation, for an increase in UTS·TE. The strength was increased to approximately 1300 MPa, nearly at the maximum of the desired strength range as shown in Table 6, Sample No. 21. However, an Al addition in combination with Mo led to similar strength as without Mo, along with an improvement in total elongation and hole expansion as shown in Table 6, Sample No. 41.

TABLE 6
Compositions (weight percent)

| Sample | | | | | | | | | | | |
|---|---|---|---|---|---|---|---|---|---|---|---|
| No. | C | Mn | Si | Cr | Mo | Al | HE | YS | UTS | UE | TE |
| 21 | 0.22 | 2.24 | 1.01 | 0.50 | 0.25 | 0.00 | 18 | 968 | 1304 | 10.8 | 15.4 |
| 41 | 0.21 | 2.27 | 0.99 | 0.50 | 0.25 | 0.4 | 34 | 989 | 1245 | 12.3 | 16.6 |

With the optimal combination of properties produced by the Si, Cr, Al and Mo alloying, a further reduction in Si was identified for better pickling and welding behavior (see Sample Nos. 45 and 50). It was found that good properties were maintained down to 0.6-0.7 weight percent Si as shown in Table 7. A Nb addition was also done, which increased strength and ductility, but hole expansion was recoded below the desired range (Table 7, Sample No. 51),

TABLE 7
Compositions (weight percent)

| Sample | | | | | | | | | | | | |
|---|---|---|---|---|---|---|---|---|---|---|---|---|
| No. | C | Mn | Si | Cr | Mo | Al | Nb | HE | YS | UTS | UE | TE |
| 45 | 0.22 | 2.27 | 0.63 | 0.50 | 0.25 | 0.43 | | 34 | 979 | 1199 | 10.2 | 14.8 |
| 50 | 0.22 | 2.26 | 0.70 | 0.50 | 0.25 | 0.43 | | 32 | 918 | 1222 | 10.8 | 15.3 |
| 51 | 0.21 | 2.29 | 0.79 | 0.50 | 0.25 | 0.41 | 0.028 | 18 | 875 | 1248 | 12.9 | 17.3 |

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting” of is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention as defined in the appended claims.

1. A quench and partition steel sheet product comprising from 0.12 to 0.5 weight percent C, from 1 to 3 weight percent Mn, from 0.4 to 1.1 weight percent Si, from 0.2 to 0.9 weight percent Cr, up to 0.5 weight percent Mo, and up to 1 weight percent Al,
wherein the steel sheet product comprises martensite, ferrite and retained austenite, and has an ultimate tensile strength of at least 1180 MPa, a total elongation of at least 13 percent, and a hole expansion of at least 25 percent.

2. The quench and partition steel sheet product of claim 1, wherein the steel sheet product comprises from 0.15 to 0.4 weight percent C, from 2 to 2.8 weight percent Mn, from 0.5 to 1.0 weight percent Si, from 0.15 to 0.8 weight percent Cr, from 0.15 to 0.4 weight percent Mo, and from 0.1 to 0.7 weight percent Al.

3. The quench and partition steel sheet product of claim 1, wherein the steel sheet product comprises from 0.2 to 0.25 weight percent C, from 2.1 to 2.5 weight percent Mn, from 0.6 to 0.9 weight percent Si, from 0.3 to 0.7 weight percent Cr, from 0.2 to 0.3 weight percent Mo, and from 0.2 to 0.5 weight percent Al.

4. The quench and partition steel sheet product of claim 1, wherein the Si comprises less than 1.0 weight percent.

5. The quench and partition steel sheet product of claim 1, wherein the Si comprises less than 0.95 weight percent.

6. The quench and partition steel sheet product of claim 1, wherein the Si comprises from 0.6 to 0.8 weight percent.

7. The quench and partition steel sheet product of claim 6, wherein the Al comprises less than 0.5 weight percent.

8. The quench and partition steel sheet product of claim 1, wherein the Al comprises less than 0.5 weight percent.

9. The quench and partition steel sheet product of claim 1, wherein the Mo comprises from 0.1 to 0.4 weight percent.

10. The quench and partition steel sheet product of claim 1, wherein the Mo comprises from 0.2 to 0.3 weight percent.

11. The quench and partition steel sheet product of claim 1, wherein the retained austenite comprises from 5 to 16 volume percent.

12. The quench and partition steel sheet product of claim 1, wherein the ultimate tensile strength is less than 1370 MPa.

13. The quench and partition steel sheet product of claim 1, wherein the total elongation is at least 14 percent.

14. The quench and partition steel sheet product of claim 1, wherein the steel sheet product has a combination of ultimate tensile strength and total elongation UTS·TE of greater than 17,000 MPa.

15. The quench and partition steel sheet product of claim 1, wherein the hole expansion is at least 30 percent.

16. The quench and partition steel sheet product of claim 1, wherein the steel sheet product has a combination of ultimate tensile strength, total elongation and hole expansion UTS·TE·HE of greater than 37.5×10⁴ MPa %².

17. The quench and partition steel sheet product of claim 16, wherein the UTS·TE·HE is greater than 50×10⁴ MPa %².

18. The quench and partition steel sheet product of claim 1, wherein the quench and partition steel sheet product comprises a galvanized coating.

19. The quench and partition steel sheet product of claim 1, wherein the quench and partition steel sheet product comprises a galvannealed coating.

20. A method of producing the quench and partition steel sheet product of claim 1 comprising:
heating the steel sheet product to a soaking temperature of at least 720° C.;
quenching the heated steel sheet product to a quench temperature below a martensite-start temperature; and
aging the quenched steel sheet product at a temperature at or above the quench temperature to thereby produce the quench and partition steel sheet product of claim 1.

21. A method of producing a quench and partition steel sheet product comprising from 0.12 to 0.5 weight percent C, from 1 to 3 weight percent Mn, from 0.4 to 1.1 weight percent Si, from 0.2 to 0.9 weight percent Cr, up to 0.5 weight percent Mo, and up to 1 weight percent Al, the method comprising:
subjecting the steel sheet product to a soaking temperature of at least 720° C.;
quenching the heated steel sheet product to a quench temperature below a martensite-start temperature; and
aging the quenched steel sheet product at an aging temperature at or above the quench temperature to thereby produce the quench and partition steel sheet product,
wherein the steel sheet product comprises martensite ferrite and retained austenite, and has an ultimate tensile strength of at least 1180 MPa, a total elongation of at least 13 percent, and a hole expansion of at least 25 percent.

22. The method of claim 21, wherein the soaking temperature is from 760 to 825° C., the quench temperature is from 150 to 350° C., and the aging temperature is from 330 to 440° C.

23. The method of claim 21, further comprising galvanizing the quench and partition steel sheet product at a temperature of from 440 to 480° C.

24. The method of claim 21, further comprising galvannealing the quench and partition steel sheet product at a temperature of from 480 to 530° C.

25. The method of claim 21, wherein the steel sheet product comprises from 0.15 to 0.4 weight percent C, from 2 to 2.8 weight percent Mn, from 0.5 to 1.0 weight percent Si, from 0.15 to 0.8 weight percent Cr, from 0.15 to 0.4 weight percent Mo, and from 0.1 to 0.7 weight percent Al.

26. The method of claim 21, wherein the steel sheet product comprises from 0.2 to 0.25 weight percent C, from 2.1 to 2.5 weight percent Mn, from 0.6 to 0.9 weight percent Si, from 0.3 to 0.7 weight percent Cr, from 0.2 to 0.3 weight percent Mo, and from 0.2 to 0.5 weight percent Al.

27. The method, of claim 21, wherein the total elongation is at least 14 percent, the steel sheet product has a combination of ultimate tensile strength and total elongation UTS·TE of greater than 17,000 MPa %, the hole expansion is at least 30 percent, and the steel sheet product has a combination of ultimate tensile strength, total elongation and hole expansion UTS·TE·HE of greater than 50×10⁴ MPa %².

28. The method of claim 21, further comprising subjecting the steel sheet product to an initial thermal cycle prior to the step of subjecting the steel sheet product to the soaking temperature.

29. The method of claim 28, wherein the initial temperature cycle comprises annealing the steel sheet product at an annealing temperature of at least 820° C. followed by quenching to a temperature below the martensite-start temperature.
